(19) United States
(12) Patent Application Publication
(10) Pub. No.: US 2009/0018271 A1
(43) Pub. Date: Jan. 15, 2009

(54) Coating Composition and Article Coated With Same

(75) Inventors: Tomihisa Ohno, Nagoya-shi (JP); Masahiro Hara, Nagoya-shi (JP); Kozo Fujii, Aichi (JP); Yoshihiro Kojima, Aichi (JP); Susumu Kawakami, Nagoya-shi (JP); Yoshikazu Fushimi, Nagoya-shi (JP)

Correspondence Address: CARSTENS & CAHOON, LLP, P O BOX 802334, DALLAS, TX, 75380, US

(73) Assignee: Natoco Co., Ltd., Nishikamo-gun, Aichi (JP)

(21) Appl. No.: 10/596,008

(22) PCT Filed: Dec. 8, 2004
(86) PCT No.: PCT/JP04/18267

§ 371 Date: May 25, 2006

(30) Foreign Application Priority Data
Dec. 8, 2003 (JP) 2003-409145
Aug. 5, 2004 (JP) 2004-229848

(51) Int. Cl. C08L 75/04

(52) U.S. Cl. 525/131; 525/123

(57) ABSTRACT

A coating composition including of a (meth)acrylic resin (A) containing a hydroxyl group and a polyisocyanate compound (B) containing a plurality of isocyanate groups. The (meth)acrylic resin (A) is obtained by copolymerizing a monomer mixture essentially containing a polycaprolactone-modified hydroxyalkyl (meth)acrylate and a hydroxyl group-containing (meth)acrylate. The coating composition is characterized in that the hydroxyl group in the hydroxyl group-containing (meth)acrylate is a primary hydroxyl group and the hydroxyl number of the (meth)acrylic resin (A) is 125-145.

### FIELD OF THE INVENTION

The present invention relates to a coating composition having satisfactory stain resistance when used in a coated film, and to an article coated therewith.

### BACKGROUND OF THE INVENTION

In recent years there has been a growing preference for high durability of coated films so that they are able to maintain a satisfactory appearance over an extended period of time. One of the factors that impairs this high durability is scratches in the coated film. The following technologies have been proposed to solve the problem of scratches.

Patent document 1 discloses a coating composition obtained by crosslinking melamine with an acrylic resin obtained by polymerizing a monomer mixture containing a caprolactone-modified hydroxyalkyl (meth)acrylate in which all or a portion of a hydroxyalkyl (meth)acrylate has been modified with ε-caprolactone. In addition, Patent document 2 discloses a curable resin composition containing a polyisocyanate compound and an acryloyl polyole resin obtained by using a lactone-modified hydroxyalkyl (meth)acrylic acid ester in which the proportion of monomers having two or more lactone chains has been reduced.

However, in Patent document 1, since melamine is used as a crosslinking agent, the coated film becomes harder than necessary, and chipping resistance and scratch resistance, which are indicators of the difficulty in separating the coated film, were inadequate. Consequently, there was the problem in which the appearance of the coated film of a coated article obtained by coating the coating composition onto a coated material was poor. Moreover, although this publication discloses 2-hydroxyethyl (meth)acrylate, 3-hydroxypropyl (meth)acrylate and 4-hydroxybutyl (meth)acrylate as monomers that are polymerized with the caprolactone-modified hydroxyalkyl (meth)acrylate to obtain an acrylic resin, none of these are provided with a primary hydroxyl group. Since an acrylic resin produced from such monomers has low reactivity with isocyanates, and curing is inadequate. Thus, there were the problems of low scratch resistance and low chipping resistance of the coated film as well as low stain resistance.

Patent document 2 discloses a coated film that uses an isocyanate resin and a (meth)acrylic resin containing a caprolactone-modified hydroxyalkyl (meth)acrylate. However, all of the hydroxyl numbers indicated in the examples of this document are high at 260, 262, 296 and 300 (Table 2). However, in the case the hydroxyl number is excessively high or excessively low, hydroxyl groups or isocyanate groups remain following the reaction with isocyanate and an uncured portion forms resulting in the problem of low stain resistance of the coated film.

The present invention was completed by focusing on the aforementioned problems of the prior art. An object of the present invention is to provide a coating composition and an article coated therewith that is able to improve the stain resistance of a coated film and demonstrate satisfactorily coating performance including appearance of a coated film.

[Patent document 1]: Japanese Laid-Open Patent Publication No. 3-160049
[Patent document 2]: Japanese Laid-Open Patent Publication No. 2002-167423

### SUMMARY OF THE INVENTION

In order to achieve the aforementioned object, a coating composition of the present invention is a coating composition comprising: a (meth)acrylic resin (A) having a hydroxyl group, which is obtained by copolymerizing a mixture having for its essential components a polycaprolactone-modified hydroxyalkyl (meth)acrylate and a different hydroxyl group-containing (meth)acrylate, and a polyisocyanate compound (B) having a plurality of isocyanate groups; wherein, the hydroxyl group of the hydroxyl group-containing (meth)acrylate is a primary hydroxyl group, and the hydroxyl number of the (meth)acrylic resin (A) is 125 to 145. Furthermore, the term “(meth)acrylate” is used in the present specification to include acrylate and methacrylate.

### DESCRIPTION OF THE PREFERRED EMBODIMENTS

The following provides a detailed explanation of embodiments of the coating composition of the present invention.

A coating composition of the present embodiment is composed of a (meth)acrylic resin (A) and a polyisocyanate compound (B) having a plurality of isocyanate groups. The (meth)acrylic resin (A) has a hydroxyl group, and is obtained by copolymerizing a monomer mixture having for its essential components a polycaprolactone-modified hydroxyalkyl (meth)acrylate and a different hydroxyl group-containing (meth)acrylate. The hydroxyl group of the hydroxyl group-containing (meth)acrylate of the present invention is a primary hydroxyl group, namely a hydroxyl group that is bonded to a primary carbon in a molecule thereof. Moreover, the hydroxyl number of the (meth)acrylic resin (A) is 125 to 145. Although this coating composition is normally used in a two-liquid form, with the (meth)acrylic resin (A) serving as a primary agent and the polyisocyanate compound (B) serving as a curing agent, it may be used in a single-liquid form in the case of using a block polyisocyanate for the polyisocyanate compound (B).

First, the (meth)acrylic resin (A) will be described.

This (meth)acrylic resin is obtained by copolymerizing a monomer mixture having for its essential components a polycaprolactone-modified hydroxyalkyl (meth)acrylate, obtained by modifying a hydroxyalkyl (meth)acrylate with caprolactone or and a different hydroxyl group-containing (meth)acrylate. Caprolactone refers to ε-caprolactone, trimethyl caprolactone or a mixture thereof. The polycaprolactone-modified hydroxyalkyl (meth)acrylate is blended to improve the scratch resistance and chipping resistance of a coated film formed from this coating composition. The polycaprolactone-modified hydroxyalkyl (meth)acrylate is a compound represented by the following general formula (1). Specific examples of this polycaprolactone-modified hydroxyalkyl (meth)acrylate include polycaprolactone-modified hydroxyethyl (meth)acrylate, polycaprolactone-modified hydroxypropyl (meth)acrylate and polycaprolactone-modified hydroxybutyl (meth)acrylate. The number of carbons n of the alkylene group is preferably 1 to 4 and most preferably 2 from the viewpoint of ease of production and ease of acquisition.

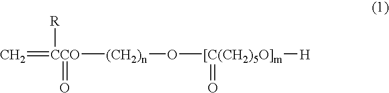

In this general formula, R represents a hydrogen atom or a methyl group, the number of carbons of the alkylene group (methylene group) is an integer from 1 to 10, and the number of caprolactone repetitive units m is an integer from 1 to 25.

In the aforementioned polycaprolactone-modified hydroxyalkyl (meth)acrylate, the average number of caprolactone repetitive units m is preferably 1 to 3 and more preferably 2 to 3 in order to enhance the scratch resistance and impact resistance of the coated film and to improve the appearance and stain resistance of the coated film. If the average number of caprolactone repetitive units exceeds 3, the caprolactone repetitive portion becomes excessively long, the strength of the coated film decreases, the scratch resistance and impact resistance of the coated film decrease, and the appearance and stain resistance of the coated film decrease. A polycaprolactone-modified hydroxyalkyl acrylate is preferably used for the aforementioned polycaprolactone-modified hydroxyalkyl (meth)acrylate in order to enhance impact resistance and improve the appearance of the coated film. This is because the glass transition temperature of a polymer of polycaprolactone-modified hydroxyalkyl acrylate is higher than that of a polymer of polycaprolactone-modified hydroxyalkyl methacrylate.

The aforementioned hydroxyl group-containing (meth)acrylate is blended to enhance reactivity with the polyisocyanate compound and improve the stain resistance of the coated film. As a result of the hydroxyl group of the hydroxyl group-containing (meth)acrylate being a primary hydroxyl group, the reactivity between the (meth)acrylic resin and polyisocyanate compound is high, and the scratch resistance, chipping resistance and stain resistance of the coated film can be improved. In contrast, in the case where the hydroxyl group of the hydroxyl group-containing (meth)acrylate is a secondary hydroxyl group such as hydroxypropyl (meth)acrylate, the reactivity between the acrylic resin and polyisocyanate compound is low, and the scratch resistance, chipping resistance and stain resistance of the coated film are also low. Examples of (meth)acrylates containing a primary hydroxyl group include 2-hydroxyethyl (meth)acrylate, 3-hydroxypropyl (meth)acrylate and 4-hydroxybutyl (meth)acrylate.

In addition to the aforementioned essential components, monomers having a cyclic backbone, other monomers as well as polymerization initiators, polymerization solvents and so forth are blended into the monomer mixture. Monomers having a cyclic backbone are blended to enhance scratch resistance of the coated film and improve the appearance thereof, and are preferably contained at 10% by mass or less in the monomer mixture. If the blended proportion of the monomer exceeds 10% by mass, the scratch resistance of the coated film decreases and the appearance of the coated film is easily impaired.

Other monomers are blended to adjust polymerization reactivity and improve the physical properties of the desired coated film, and specific examples of other monomers used include methyl (meth)acrylate, ethyl (meth)acrylate, propyl (meth)acrylate, butyl (meth)acrylate, 2-ethylhexyl (meth)acrylate, (meth)acrylic acid and maleic acid. Examples of polymerization initiators used include 1,1′-azobis-1-cyclohexanecarbonitrile, azobis-2-methylbutyronitrile and t-butyl hydroperoxide. Examples of polymerization solvents used include aromatic hydrocarbons such as benzene and toluene, ketones such as acetone and methyl isobutyl ketone, esters such as ethyl acetate and ethers such as dioxane.

The desired (meth)acrylic resin (A) is obtained by heating and polymerizing the monomer mixture in accordance with ordinary methods. The hydroxyl number of the resulting (meth)acrylic resin (A) is 125 to 145 and preferably 130 to 145. In the case the hydroxyl number of the (meth)acrylic resin (A) is less than 125, the reactivity with the polyisocyanate compound is inadequate and the stain resistance of the coated film cannot be improved. On the other hand, in the case the hydroxyl number of the (meth)acrylic resin (A) exceeds 145, since the hydroxyl number is excessively high, hydroxyl groups that do not react with the polyisocyanate compound remain, the appearance of the coated film is impaired by this uncured portion, and the coated film is no longer able to fulfill its function as a coated film.

In addition, it is preferable that the acid number of the (meth)acrylic resin (A) be 3 mg KOH/g or less. Although this acid number is determined by the amount of acids such as methacrylic acid added, the acid number can also be made to be 0 mg KOH/g by not adding any acid. In the case of coating the same coating composition twice in particular, affinity between both coated films is improved, and the acid acts as a catalyst for the reaction between, for example, the hydroxyl group and the isocyanate groups, thereby inhibiting the progression of curing and improving adhesion between both coated films. If the acid number exceeds 3 mg KOH/g, these effects are unable to be obtained.

In the coating composition, the acid number of the (meth)acrylic resin (A) is preferably set to 3 mg KOH/g or less. In this case, when the same coating composition has been coated twice (self-recoating) in particular, since the acid radicals in the coated film that has been coated onto the surface of a coated material are oriented on the side of the coated material, the surface of the coated film is presumed to become deficient in acid radicals. Thus, by lowering the acid number of the (meth)acrylic resin (A), in addition to being able to improve the affinity between the coated film formed on the surface of the coated material and the coated film provided thereon, the acid acts as a catalyst of the reaction between, for example, the hydroxyl group and the isocyanate groups, which is presumed to inhibit the progression of curing and decreases adhesion between both coated films. Thus, the adhesion of the coated film can be improved. In this case, the durability of the coated film can also be improved.

Continuing, an explanation is provided for the polyisocyanate compound (B).

This polyisocyanate compound is an organic compound having a plurality of isocyanate groups in a single molecule thereof, and the number of isocyanate groups contained in a single molecule of the polyisocyanate compound is preferably three or more. Such a polyisocyanate compound is able to react with the (meth)acrylic resin (A) having a hydroxyl group and form a crosslinked structure that is able to improve the physical properties of the coated film.

Examples of polyisocyanate compounds having two isocyanate groups in a single molecule thereof include diisocyanate monomers such as tolylene diisocyanate, naphthalene diisocyanate, diphenylmethane diisocyanate, isophorone diisocyanate, xylylene diisocyanate, hexamethylene diisocyanate, dicyclohexylmethane diisocyanate, 2,2,4-trimethylhexamethylene diisocyanate, methyl-2,6-diisocyanate hexanoate and norbornane diisocyanate. Examples of polyisocyanate compounds having three or more isocyanate groups in a single molecule thereof include compounds represented by the following general formula (2) in which a diisocyanate monomer has been modified by isocyanurate, compounds represented by the following general formula (3) in which a diisocyanate monomer has been modified with an adduct, compounds represented by the following general formula (4) in which a diisocyanate monomer has been modified with a biuret, and isocyanate prepolymers such as 2-isocyanate ethyl-2,6-diisocyanate caproate and triaminononane triisocyanate.

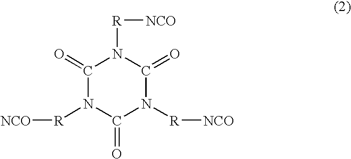

### R is

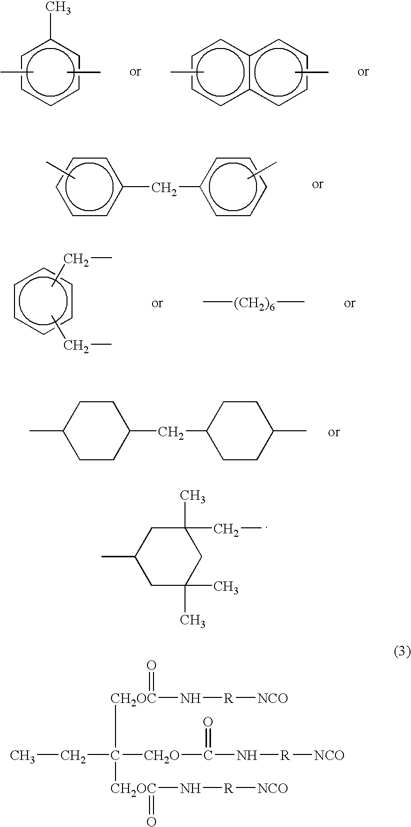

R is the same as in the case of general formula (1) above.

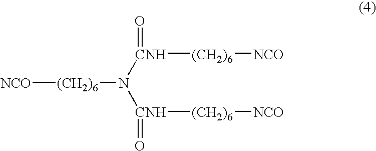

Moreover, by using a block polyisocyanate in which the isocyanate groups have been blocked with a blocking agent for the polyisocyanate compound, the coating composition can be used in a single-liquid form. Namely, since the isocyanate groups of the polyisocyanate compound are blocked with a blocking agent, there is no reaction with the (meth)acrylic resin having a hydroxyl group, and is able to remain stable in the form of a single liquid. By heating the coating composition after coating onto a coated material, the block polyisocyanate undergoes a decomposition reaction resulting in the formation of isocyanate groups, and the coated film is cured as a result of the hydroxyl group of the (meth)acrylic resin reacting with those isocyanate groups. Examples of block polyisocyanates include isocyanurate type block isocyanates of hexamethylene diisocyanate. Examples of blocking agents include phenol-based, oxime-based and alcohol-based compounds.

Although the coating composition is obtained from the (meth)acrylic resin (A) and the polyisocyanate compound (B), which are obtained in the manner described above, a lactone polyole (C), an ultraviolet absorber, a photostabilizer or a solvent and so forth are also blended as necessary. The lactone polyole (C) is blended to enhance scratch resistance, chipping resistance and impact resistance as well as improve the appearance of the coated film without impairing the stain resistance of the coated film, and more specifically, is preferably a lactone polyole (C) having three or more hydroxyl groups, and more preferably a lactone tetraole having four hydroxyl groups. The number average molecular weight of the lactone polyole (C) is preferably 350 to 1500. In the case where the number average molecular weight is less than 350, the number of hydroxyl groups per molecular weight becomes excessively large, while in case the number average molecular weight exceeds 1500, the number of hydroxyl groups per molecular weight becomes excessively small, which are not preferable since they result in the occurrence of bias in the reaction with the polyisocyanate compound.

Examples of ultraviolet absorbers that are used include benzotriazole-based compounds. Examples of photostabilizers used include piperidine-based and hindered amine-based compounds. Examples of solvents used include alcohols, esters and aromatic compounds. A coated article is obtained by coating this coating composition onto the surface of a coated material followed by drying and curing at normal temperatures or drying and curing by heating to form a coated film on the surface of the coated material. The reaction temperature of the reaction between the hydroxyl group of the (meth)acrylic resin (A) and the isocyanate groups of the polyisocyanate compound (B) is preferably ordinary temperature to 100° C., and the reaction time is preferably 1 to 10 hours. Coating may be carried out in accordance with an ordinary method, and methods that are employed include air spraying, airless spraying, electrostatic coating, roll coating, flow coating and spin coating. The thickness of the resulting coated film is preferably about 1 to 100 μm. In this manner, the hydroxyl group of the (meth)acrylic resin (A) and isocyanate groups of the polyisocyanate compound (B) react to form urethane (meth)acrylate.

A coating composition as explained above can be preferably used for applications in fields requiring coating performance such as stain resistance and a satisfactory coated film appearance. Specific examples of applications in which the coating composition is coated and used include electrical and electronic equipment such as cellular telephones, wristwatches, compact discs, optical discs, audio equipment and office automation equipment; electronic material components such as anti-reflection plates of touch panels and CRT tubes; home appliances such as refrigerators, vacuum cleaners and microwave ovens; automobile interior components such as instrument panels and dashboards; precoated metal steel sheets; automobile parts such as automobile bodies, bumpers, spoilers, door handles, steering wheels, headlights, motorcycle gasoline tanks, and aluminum wheels or door mirrors subjected to plating, deposition or sputtering; carport roofs and roofs for natural light; plastic molded articles made of polyvinyl chloride, acrylic resin, polyethylene terephthalate, polycarbonate or ABS resin; wooden products such as stairways, floors, desks, chairs, dressers and other furniture; and cloth, paper, sunglasses and corrective eyeglasses.

In order to prepare a coating composition, the (meth)acrylic resin (A) is first synthesized by copolymerizing a monomer mixture having for its essential components a polycaprolactone-modified hydroxyalkyl(meth)acrylate and another hydroxyl group-containing (meth)acrylate. A coating composition is obtained by mixing the resulting (meth)acrylic resin (A) and polyisocyanate compound (B). A coated film is then formed on the surface of a coated material by coating this coating composition onto the surface of a coated material followed by drying and curing at room temperature or by drying and curing by heating.

In this case, since the hydroxyl group of the (meth)acrylic resin originates in the hydroxyl group-containing (meth)acrylate and that hydroxyl group is a primary hydroxyl group, the reactivity with the polyisocyanate compound is higher than a (meth)acrylic resin provided with a secondary hydroxyl group, curing is able to proceed adequately, and the scratch resistance, chipping resistance and stain resistance of the coated film can be improved. Moreover, since the hydroxyl number of the (meth)acrylic resin (A) is set to be within the range of 125 to 145, the hydroxyl group of the (meth)acrylic resin and the polyisocyanate compound are cured by reacting without hardly any excess or shortage, thereby making it possible to demonstrate improved coating performance, such as stain resistance capable of inhibiting staining of the coated film surface, and therefore maintain a satisfactory coated film appearance.

Moreover, since the coated film has the (meth)acrylic resin for its base resin, it has superior weather resistance, as well as since the (meth)acrylic resin is crosslinked and cured by the polyisocyanate compound, the chemical resistance of the coated film can also be improved.

### EXAMPLES

### Synthesis Examples 1 to 15, Examples 1 to 18 and Comparative Examples 1 to 6

The following provides a more detailed explanation of the aforementioned embodiments through their synthesis examples, examples and comparative examples. It should be noted that the abbreviations used in each of the examples are as indicated below. In addition, the term “parts” used for the mixing ratios indicates parts by mass, while “%” indicates percent by mass.

D170N refers to Takenate D170N (Mitsui Takeda Chemicals, NCO content=20.9%, solid content: 100%), and is a molecule in which hexamethylene diisocyanate has been modified with isocyanurate.

D110N refers to Takenate D110N (Mitsui Takeda Chemicals, NCO content=11.5%, solid content: 75%), and is a molecule in which trimethylolpropane (TMP) has been reacted with xylylene diisocyanate, namely a TMP adduct type of xylylene diisocyanate.

D140N refers to Takenate D140N (Mitsui Takeda Chemicals, NCO content=10.8%, solid content=75%), and is a molecule in which trimethylolpropane (TMP) has been reacted with isophorone diisocyanate, namely a TMP adduct type of isophorone diisocyanate.

VPLS2253 refers to Desmodur VPLS2253 (Sumika Bayer Urethane, NCO content=10.5%, solid content: 75%), and is an isocyanurate type of block isocyanate of hexamethylene diisocyanate.

Lactone Tetraole 405 refers to a lactone tetraole (Daicel Chemical Industries, Plaxel 405, molecular weight: 500).

Lactone Tetraole 410D refers to a lactone tetraole (Daicel Chemical Industries, Plaxel 410D, molecular weight: 1000).

Lactone Triole 305 refers to a lactone triole (Daicel Chemical Industries, Plaxel 305, molecular weight: 500).

Lactone Triole 312 refers to a lactone triole (Daicel Chemical Industries, Plaxel 312D, molecular weight: 1250).

Lactone Triole 410D refers to a lactone triole (Daicel Chemical Industries, Plaxel 320, molecular weight: 2000).

BYK-110 refers to an acrylic copolymer containing an acid radical (BYK Chemie).

BYK-051 refers to a silicone-free foam breaker (BYK Chemie).

### Synthesis Example 1

### Preparation of (Meth)acrylic Resin

100 parts by mass (hereinafter referred to simply as “parts”) of methyl isobutyl ketone were charged into a 500 ml volumetric flask equipped with a stirrer, thermometer, condenser and nitrogen gas feed tube and heated to 110° C. Separate from this, 26 parts of methyl methacrylate (MMA), is parts of butyl methacrylate (BMA), 35 parts of polycaprolactone-modified hydroxyethyl acrylate (Daicel Chemical Industries, Plaxel FA2D), 20 parts of 2-hydroxyethyl methacrylate (2-HEMA), 1 part of methacrylic acid (MAR) and 2 parts of 1,1′-azobis-1-cyclohexanecarbonitrile (Otsuka Chemical, ACHN) were mixed. This monomer mixture was dropped in over the course of 2 hours and allowed to react for 3 hours.

Subsequently, 5 parts of methyl isobutyl ketone (MIBK), 0.1 part of 1,1′-azobis-1-cyclohexane carbonitrile and 0.1 part of azobis-2-methylbutyronitrile (Japan Hydrazine, ABN-E) were dropped in and allowed to react for 1 hour. Moreover, 5 parts of methyl isobutyl ketone, 0.1 part of 1,1′-azobis-1-cyclohexane carbonitrile and 0.1 part of azobis-2-methylbutyronitrile were dropped in and allowed to react for 2 hours to obtain a (meth)acrylic resin A1. The (meth)acrylic resin A1 had a solid content of 47.6%, hydroxyl number of 68 (143 as solid content) and acid number (acid number per solid content of acrylic resin A1) of 6.5 mg KOH/g.

Since the same polymerization initiators and solvents are used in the preparation method of the (meth)acrylic resins, only the blending of monomers is explained in the following synthesis examples. All of the solid contents are 47.6%.

### Synthesis Examples 2 to 15

Acrylic resins were prepared in the same manner as Synthesis Example 1 with the exception of changing the types of monomers and the number of hydroxyl group used in Synthesis Example 1 as shown in Tables 1 and 2. The abbreviations used in Tables 1 and 2 are as shown below.

FA1 indicates a polycaprolactone-modified hydroxyethyl acrylate (Daicel Chemical Industries, Plaxel FA1).

FM2 indicates a polycaprolactone-modified hydroxyethyl acrylate (Daicel Chemical Industries, Plaxel FM2).

FA3 indicates a polycaprolactone-modified hydroxyethyl acrylate (Daicel Chemical Industries, Plaxel FA3).

HPMA indicates 1-hydroxypropyl methacrylate.

2-HPMA indicates 2-hydroxypropyl methacrylate.

CHMA indicates cyclohexyl methacrylate.

STY indicates styrene.

### Synthesis Examples 16 and 17

Acrylic resins were prepared in the same manner as Synthesis Example 1 with the exception of changing the types of monomers and hydroxyl group used in Synthesis Example 1 as shown in Table 2. The acid numbers of the acrylic resins (acid number per solid content of acrylic resin) were 2.6 mg KOH/g in Synthesis Example 16 and 0 mg KOH/g in Synthesis Example 17.

### Comparative Synthesis Examples 1 and 2

Acrylic resins were prepared in the same manner as Synthesis Example 1 with the exception of blending such that the amounts of the monomers having a cyclic backbone (CHMA, STY) as shown in Synthesis Examples 10 and 11 in Table 1 were increased by 10%.

TABLE 1

| | Synthesis | Synthesis | Synthesis | Synthesis | Synthesis | Synthesis | Synthesis | Synthesis | Synthesis |
|---|---|---|---|---|---|---|---|---|---|
| | Example 1 | Example 2 | Example 3 | Example 4 | Example 5 | Example 6 | Example 7 | Example 8 | Example 9 |
| MMA | 26 | 26 | 18 | 18 | 30 | 26 | 30 | 25 | 27 |
| BMA | 18 | 18 | 18 | 18 | 24 | 18 | 21 | 17 | 21 |
| FA1 | — | — | — | — | — | — | 35 | — | — |
| FA2D | 35 | 35 | 35 | 35 | 20 | — | — | — | 35 |
| FM2 | — | — | — | — | — | 35 | — | — | — |
| FA3 | — | — | — | — | — | — | — | 35 | — |
| 2-HEMA | 20 | — | 20 | 20 | 25 | 20 | 13 | 22 | 16 |
| HPMA | — | 20 | — | — | — | — | — | — | — |
| 2-HPMA | — | — | — | — | — | — | — | — | — |
| CHMA | — | — | 8 | — | — | — | — | — | — |
| STY | — | — | — | 8 | — | — | — | — | — |
| MAA | 1 | 1 | 1 | 1 | 1 | 1 | 1 | 1 | 1 |
| Hydroxyl | 143 | 135 | 143 | 143 | 140 | 141 | 141 | 138 | 126 |
| number | | | | | | | | | |

TABLE 2

| | Synthesis | Synthesis | Synthesis | Synthesis | Synthesis | Synthesis | Synthesis | Synthesis |
|---|---|---|---|---|---|---|---|---|
| | Example 10 | Example 11 | Example 12 | Example 13 | Example 14 | Example 15 | Example 16 | Example 17 |
| MMA | 25 | 25 | 30 | 24 | 26 | 28 | 26.6 | 27 |
| BMA | 7 | 7 | 25 | 17 | 18 | 18 | 18 | 18 |
| FA1 | — | — | — | — | — | — | — | — |
| FA2D | 35 | 35 | 35 | 35 | 35 | 30 | 35 | 35 |
| FM2 | — | — | — | — | — | — | — | — |
| FA3 | — | — | — | — | — | — | — | — |
| 2-HEMA | 20 | 20 | 9 | 23 | — | 15 | 20 | 20 |
| HPMA | — | — | — | — | — | — | — | — |
| 2-HPMA | — | — | — | — | 20 | — | — | — |
| CHMA | 12 | — | — | — | — | — | — | — |
| STY | — | 12 | — | — | — | 8 | — | — |
| MAA | 1 | 1 | 1 | 1 | 1 | 1 | 0.4 | — |
| Hydroxyl | 143 | 143 | 96 | 156 | 135 | 114 | 143 | 143 |
| number | | | | | | | | |

### Example 1

77 parts of (meth)acrylic resin A1 obtained in Synthesis Example 1, 10 parts of lactone tetraole (Daicel Chemical Industries, Plaxel 410D, the number of hydroxyl group: 224), 0.4 parts of ultraviolet absorber (Ciba-Geigy, Tinuvin 400), 0.4 parts of photostabilizer (Ciba-Geigy, Tinuvin 123) and 12.2 parts of MIBK were mixed to obtain the primary agent. Next, 53 parts of an isocyanurate-modified type of hexamethylene diisocyanate (Mitsui Takeda Chemicals, Takenate D-170N, NCO %=20.9%) and 47 parts of butyl acetate were mixed to obtain a curing agent. The primary agent and curing agent were formulated at a mass ratio of 2:1 to obtain prototype coating composition a. The solid content was 47.6%. Since the method for preparing the (meth)acrylic resin is the same in each of the following examples, the solid contents were all 47.6%.

### Examples 2 to 18

Coating compositions were obtained in the same manner as Example 1 with the exception of changing the types and amounts of the acrylic resin, lactone polyole, polyisocyanate, solvent and photostabilizer as shown in Table 3.

### Examples 19 to 22

Coating compositions were obtained in the same manner as Example 1 with the exception of changing the types and amounts of the acrylic resin, lactone polyole, polyisocyanate, solvent and photostabilizer as shown in Table 3.

### Comparative Example 1

An acrylmelamine coating (Natoco, Acrystoclear) was used for Comparative Example 1.

### Comparative Example 2

An acrylurethane coating (Natoco, Gameronclear) was used for Comparative Example 2.

### Comparative Examples 3 to 6

Coating compositions were obtained in the same manner as Example 1 with the exception of changing the types and amounts of the acrylic resin, lactone polyole, polyisocyanate, solvent and photostabilizer as shown in Table 3.

TABLE 3

| Example or | | | | | | | |
|---|---|---|---|---|---|---|---|
| Comparative | (Meth)acrylic | Lactone | | | Butyl | Tinuvin | Tinuvin |
| Example | resin | polyole | Polyisocyanate | MIBK | acetate | 400 | 123 |
| Example 1 | Synthesis | Tetraole | D170N: | 12.2 | 23.5 | 0.4 | 0.4 |
| | Example 1: | 410D: 10 | 26.5 | parts | parts | parts | parts |
| | 77 parts | parts | parts | | | | |
| Example 2 | Synthesis | Tetraole | D170N: | 12.2 | 23.5 | 0.4 | 0.4 |
| | Example 1: | 405: 10 | 26.5 | parts | parts | parts | parts |
| | 77 parts | parts | parts | | | | |
| Example 3 | Synthesis | Triole | D170N: | 12.2 | 23.5 | 0.4 | 0.4 |
| | Example 1: | 305: 10 | 26.5 | parts | parts | parts | parts |
| | 77 parts | parts | parts | | | | |
| Example 4 | Synthesis | Triole | D170N: | 12.2 | 23.5 | 0.4 | 0.4 |
| | Example 1: | 312: 10 | 26.5 | parts | parts | parts | parts |
| | 77 parts | parts | parts | | | | |
| Example 5 | Synthesis | Tetraole | D110N: | 12.2 | — | 0.4 | 0.4 |
| | Example 1: | 410D: 10 | 53 parts | parts | | parts | parts |
| | 77 parts | parts | | | | | |
| Example 6 | Synthesis | Tetraole | D140N: | 12.2 | — | 0.4 | 0.4 |
| | Example 1: | 410D: 10 | 53 parts | parts | | parts | parts |
| | 77 parts | parts | | | | | |
| Example 7 | Synthesis | Tetraole | VPLS2253: | 12.2 | — | 0.4 | 0.4 |
| | Example 1: | 410D: 10 | 53 | parts | | parts | parts |
| | 77 parts | parts | parts | | | | |
| Example 8 | Synthesis | — | D170N: | 12.2 | 23.5 | 0.4 | 0.4 |
| | Example 1: | | 26.5 | parts | parts | parts | parts |
| | 77 parts | | parts | | | | |
| Example 9 | Synthesis | Tetraole | D170N: | 12.2 | 23.5 | 0.4 | 0.4 |
| | Example 2: | 410D: 10 | 26.5 | parts | parts | parts | parts |
| | 77 parts | parts | parts | | | | |
| Example 10 | Synthesis | Tetraole | D170N: | 12.2 | 23.5 | 0.4 | 0.4 |
| | Example 3: | 410D: 10 | 26.5 | parts | parts | parts | parts |
| | 77 parts | parts | parts | | | | |
| Example 11 | Synthesis | Tetraole | D170N: | 12.2 | 23.5 | 0.4 | 0.4 |
| | Example 4: | 410D: 10 | 26.5 | parts | parts | parts | parts |
| | 77 parts | parts | parts | | | | |
| Example 12 | Synthesis | Tetraole | D170N: | 12.2 | 23.5 | 0.4 | 0.4 |
| | Example 5: | 410D: 10 | 26.5 | parts | parts | parts | parts |
| | 77 parts | parts | parts | | | | |
| Example 13 | Synthesis | Tetraole | D170N: | 12.2 | 23.5 | 0.4 | 0.4 |
| | Example 6: | 410D: 10 | 26.5 | parts | parts | parts | parts |
| | 77 parts | parts | parts | | | | |
| Example 14 | Synthesis | Tetraole | D170N: | 12.2 | 23.5 | 0.4 | 0.4 |
| | Example 7: | 410D: 10 | 26.5 | parts | parts | parts | parts |
| | 77 parts | parts | parts | | | | |
| Example 15 | Synthesis | Tetraole | D170N: | 12.2 | 23.5 | 0.4 | 0.4 |
| | Example 8: | 410D: 10 | 26.5 | parts | parts | parts | parts |
| | 77 parts | parts | parts | | | | |
| Example 16 | Synthesis | Tetraole | D170N: | 12.2 | 23.5 | 0.4 | 0.4 |
| | Example 9: | 410D: 10 | 26.5 | parts | parts | parts | parts |
| | 77 parts | parts | parts | | | | |
| Example 17 | Synthesis | Tetraole | D170N: | 12.2 | 23.5 | 0.4 | 0.4 |
| | Example 10: | 410D: 10 | 26.5 | parts | parts | parts | parts |
| | 77 parts | parts | parts | | | | |
| Example 18 | Synthesis | Tetraole | D170N: | 12.2 | 23.5 | 0.4 | 0.4 |
| | Example 11: | 410D: 10 | 26.5 | parts | parts | parts | parts |
| | 77 parts | parts | parts | | | | |
| Example 19 | Synthesis | Tetraole | D170N: | 12.2 | 23.5 | 0.4 | 0.4 |
| | Example 16: | 410D: 10 | 26.5 | parts | parts | parts | parts |
| | 77 parts | parts | parts | | | | |
| Example 20 | Synthesis | Tetraole | D170N: | 12.2 | 23.5 | 0.4 | 0.4 |
| | Example 17: | 410D: 10 | 26.5 | parts | parts | parts | parts |
| | 77 parts | parts | parts | | | | |
| Example 21 | Synthesis | Tetraole | D170N: | 12.2 | 23.0 parts, | 0.4 | 0.4 |
| | Example 17: | 410D: 10 | 26.5 | parts | BYK110: 0.5 | parts | parts |
| | 77 parts | parts | parts | | parts | | |
| Example 22 | Synthesis | Tetraole | D170N: | 12.2 | 23.0 parts, | 0.4 | 0.4 |
| | Example 17: | 410D: 10 | 26.5 | parts | BYK110: 0.5 | parts | parts |
| | 77 parts | parts | parts | | parts | | |
| Comparative | Synthesis | Tetraole | D170N: | 12.2 | 23.5 | 0.4 | 0.4 |
| Example 3 | Example 12: | 410D: 10 | 26.5 | parts | parts | parts | parts |
| | 77 parts | parts | parts | | | | |
| Comparative | Synthesis | Tetraole | D170N: | 12.2 | 23.5 | 0.4 | 0.4 |
| Example 4 | Example 13: | 410D: 10 | 26.5 | parts | parts | parts | parts |
| | 77 parts | parts | parts | | | | |
| Comparative | Synthesis | Tetraole | D170N: | 12.2 | 23.5 | 0.4 | 0.4 |
| Example 5 | Example 14: | 410D: 10 | 26.5 | parts | parts | parts | parts |
| | 77 parts | parts | parts | | | | |
| Comparative | Synthesis | Tetraole | D170N: | 12.2 | 23.5 | 0.4 | 0.4 |
| Example 6 | Example 15: | 410D: 10 | 26.5 | parts | parts | parts | parts |
| | 77 parts | parts | parts | | | | |

Next, the appearance of the coated film, scratch resistance, impact resistance, stain resistance and weather resistance of the coating compositions prepared in the aforementioned examples and comparative examples were measured according to the following methods. Those test results are shown in Table 4.

<Test Plate Production Process>

1) White acrylmelamine coating (Natoco) was coated onto a bonderizing steel plate (Nippon Testpanel) by air spraying to a film thickness of 20 μm when dry.

2) The coating composition was dried at 130° C. for 10 minutes.

3) Next, the coating compositions of Examples 1 to 18 and the coating compositions of Comparative Examples 1 and 2 were diluted with a predetermined amount of paint thinner and coated to film thickness of 15 μm when dry.

4) All of the coating compositions were dried at 130° C. for 20 minutes to obtain testpieces.

### <Test Parameters>

Coating appearance: The condition of the surfaces of the coated films were observed visually and evaluated (evaluated as ◯: good or X: poor).

Scratch resistance: Luster retention rate (mirrored surface reflection at 60 degrees) was measured after scratching for 50 times and 100 times with #0000 steel wool at a load of 500 g. Here, “#000” refers to the grade of the steel wool, and indicates that the steel wool is ultrafine.

Impact resistance: Each test piece was cooled to −10° C. and then tested with a Dupont Impact Tester at a diameter of ¼ inch, load of 500 g and distance of 500 cm followed by evaluating according to the following criteria. No cracking of coated film: ◯, some cracking of coated film: Δ, cracking of coated film: X.

Stain resistance: Grease (Showa Shell Sekiyu, Retinax Grease CL1) was uniformly coated onto each testpiece to a thickness of 5 mm. The testpieces were allowed to stand at 50° C. for 24 hours followed by removing the grease with petroleum benzene. Next, the testpieces were held for 24 hours in a sunshine weatherometer. The changes in color difference were then measured for the resulting testpieces.

Weather resistance: The luster retention rate (%) and color difference of the testpieces were measured after holding for 2000 hours in a sunshine weatherometer.

TABLE 4

| | | Scratch resistance | | | | Weather resistance | |
|---|---|---|---|---|---|---|---|
| | Coated | 50 times | 150 times | | | Luster | |
| | film | back and | back and | Impact | Stain | retention | Color |
| Example | appearance | forth | forth | resistance | resistance | rate | difference |
| Example 1 | ◯ | 96 | 75 | ◯ | 3.5 | 83 | 0.51 |
| Example 2 | ◯ | 96 | 71 | ◯ | 2.4 | 81 | 0.66 |
| Example 3 | ◯ | — | 66 | ◯ | 4.1 | 84 | 0.75 |
| Example 4 | ◯ | 97 | 72 | ◯ | 4.9 | 79 | 0.98 |
| Example 5 | ◯ | 94 | 64 | ◯ | 3.2 | 85 | 1.21 |
| Example 6 | ◯ | 95 | 63 | ◯ | 3.3 | 86 | 0.81 |
| Example 7 | ◯ | 97 | 77 | ◯ | 3.7 | 83 | 0.52 |
| Example 8 | ◯ | 92 | 64 | ◯ | 2.9 | 81 | 0.88 |
| Example 9 | ◯ | 94 | 70 | ◯ | 3.6 | 79 | 0.51 |
| Example 10 | ◯ | 90 | 72 | ◯ | 3.2 | 88 | 0.59 |
| Example 11 | ◯ | 92 | 73 | ◯ | 3.5 | 81 | 0.57 |
| Example 12 | ◯ | 83 | 65 | ◯ | 2.9 | 85 | 0.66 |
| Example 13 | ◯ | 94 | 71 | Δ | 3.0 | 84 | 0.56 |
| Example 14 | ◯ | 89 | 62 | Δ | 2.6 | 86 | 0.88 |
| Example 15 | ◯ | 95 | 76 | ◯ | 3.8 | 88 | 0.74 |
| Example 16 | ◯ | 96 | 72 | ◯ | 4.9 | 82 | 1.06 |
| Example 17 | ◯ | 68 | 49 | ◯ | 3.8 | 79 | 0.58 |
| Example 18 | ◯ | 66 | 51 | ◯ | 3.6 | 78 | 0.60 |
| Example 19 | ◯ | 95 | 74 | ◯ | 3.7 | 82 | 0.53 |
| Example 20 | ◯ | 94 | 76 | ◯ | 3.8 | 80 | 0.52 |
| Example 21 | ◯ | 96 | 77 | ◯ | 3.5 | 80 | 0.50 |
| Example 22 | ◯ | 93 | 75 | ◯ | 3.8 | 83 | 0.52 |
| Comparative | ◯ | 72 | 42 | X | 3.2 | 81 | 0.85 |
| Example 1 | | | | | | | |
| Comparative | ◯ | 65 | 38 | Δ | 3.9 | 64 | 2.34 |
| Example 2 | | | | | | | |
| Comparative | ◯ | 95 | 70 | ◯ | 7.6 | 80 | 1.12 |
| Example 3 | | | | | | | |
| Comparative | X | 94 | 69 | Δ | 2.9 | 74 | 0.53 |
| Example 4 | | | | | | | |
| Comparative | ◯ | 90 | 58 | Δ | 5.8 | 77 | 0.58 |
| Example 5 | | | | | | | |
| Comparative | ◯ | 86 | 70 | ◯ | 7.2 | 76 | 0.53 |
| Example 6 | | | | | | | |

As shown in Table 4, Examples 1 to 18 demonstrated satisfactory stain resistance as well as coated film appearance, scratch resistance, impact resistance and weather resistance. More specifically, based on a comparison of Examples 1, 3 and 4, tetraole demonstrated better stain resistance than triole with respect to the lactone polyole. Moreover, based on a comparison of Examples 3 and 4, the larger the molecular weight of the lactone polyole, the poorer the results for stain resistance. Based on a comparison of Examples 1, 5 and 6, performance was nearly maintained even if the type of polyisocyanate of the curing agent was changed. Based on a comparison of Examples 1 and 8, scratch resistance was improved by combining the use of a lactone polyole. Based on a comparison of Examples 9 and 16, Example 9, having a high hydroxyl number (hydroxyl number: 135) demonstrated better stain resistance and weather resistance than Example 16 having a low hydroxyl number (hydroxyl number: 126).

Based on a comparison of Examples 1, 10, 11, 17 and 18, although performance was nearly maintained even if the amount of monomer having a cyclic backbone used for the acrylic resin was 10% or less, if the copolymerized amount of the monomer exceeded 10%, scratch resistance tended to decrease. Based on a comparison of Examples 1 and 13, although the difference between polycaprolactone-modified acrylate and polycaprolactone-modified methacrylate is small, acrylate resulted in somewhat better impact resistance. Based on a comparison of Examples 1, 14, 15 and 16, those in which the average value of the number of caprolactone repetitive units of the acrylic resin of 2 to 3 were superior in terms of performance. If the average value of the number of caprolactone repetitive units was 1, impact performance tended to decrease somewhat.

In contrast, scratch resistance and impact resistance were inadequate in the common acrylmelamine coating and acrylurethane coating of Comparative Examples 1 and 2. The stain resistance of Comparative Examples 3 and 6 was poor due to the low hydroxyl numbers of the acrylic resin in comparison with Example 1. In Comparative Example 4, the appearance of the coated film was impaired and it was unable to fulfill the function of a coated film since the hydroxyl number of the acrylic resin was too high as compared with Example 1. The stain resistance and scratch resistance of Comparative Example 5 were poor in comparison with Example 1 since a monomer containing a secondary hydroxyl group was used for the acrylic resin.

Next, self-recoatability was evaluated as described below for Examples 1, 19, 20, 21 and 22.

(Self-Recoatability Test Method)

1) A bonderizing steel plate (Engineering Test Service) was degreased with paint thinner and spray-coated with a black acrylmelamine coating (Natoco, Acryst Black) followed by drying at 140° C. for 20 minutes.

2) Subsequently, the same coating composition was spray-coated and dried at 100° C. for 20 minutes, at 120° C. for 20 minutes, at 140° C. for 20 minutes and at 160° C. for 20 minutes, respectively, to form a coated film (first coat).

3) Subsequently, the same coating composition was spray-coated followed by drying at 100° C. for 20 minutes, at 120° C. for 20 minutes, at 140° C. for 20 minutes and at 160° C. for 20 minutes, respectively, to form a coated film for use as the testpiece (second coat).

4) Self-recoatability was confirmed with the crosscut test (100 squares measuring 2 mm×2 mm) one week after baking and drying.

The results for Example 1 are shown in Table 5, those for Example 19 are shown in Table 6, those for Example 20 are shown in Table 7, those for Example 21 are shown in Table 8, and those for Example 22 are shown in Table 9.

TABLE 5

| | | First coat | | | |
|---|---|---|---|---|---|
| | | 100° C., | 120° C., | 140° C., | 160° C., |
| | | 20 | 20 | 20 | 20 |
| | | minutes | minutes | minutes | minutes |
| Second | 100° C., 20 | 100/100 | 50/100 | 0/100 | 0/100 |
| coat | minutes | | | | |
| | 120° C., 20 | 100/100 | 80/100 | 0/100 | 0/100 |
| | minutes | | | | |
| | 140° C., 20 | 100/100 | 100/100 | 30/100 | 0/100 |
| | minutes | | | | |
| | 160° C., 20 | 100/100 | 100/100 | 50/100 | 0/100 |
| | minutes | | | | |

TABLE 6

| | | First coat | | | |
|---|---|---|---|---|---|
| | | 100° C., | 120° C., | 140° C., | 160° C., |
| | | 20 | 20 | 20 | 20 |
| | | minutes | minutes | minutes | minutes |
| Second | 100° C., 20 | 100/100 | 90/100 | 70/100 | 0/100 |
| coat | minutes | | | | |
| | 120° C., 20 | 100/100 | 100/100 | 90/100 | 10/100 |
| | minutes | | | | |
| | 140° C., 20 | 100/100 | 100/100 | 95/100 | 10/100 |
| | minutes | | | | |
| | 160° C., 20 | 100/100 | 100/100 | 100/100 | 20/100 |
| | minutes | | | | |

TABLE 7

| | | First coat | | | |
|---|---|---|---|---|---|
| | | 100° C., | 120° C., | 140° C., | 160° C., |
| | | 20 | 20 | 20 | 20 |
| | | minutes | minutes | minutes | minutes |
| Second | 100° C., 20 | 100/100 | 100/100 | 100/100 | 100/100 |
| coat | minutes | | | | |
| | 120° C., 20 | 100/100 | 100/100 | 100/100 | 100/100 |
| | minutes | | | | |
| | 140° C., 20 | 100/100 | 100/100 | 100/100 | 100/100 |
| | minutes | | | | |
| | 160° C., 20 | 100/100 | 100/100 | 100/100 | 100/100 |
| | minutes | | | | |

TABLE 8

| | | First coat | | | |
|---|---|---|---|---|---|
| | | 100° C., | 120° C., | 140° C., | 160° C., |
| | | 20 | 20 | 20 | 20 |
| | | minutes | minutes | minutes | minutes |
| Second | 100° C., 20 | 100/100 | 100/100 | 100/100 | 100/100 |
| coat | minutes | | | | |
| | 120° C., 20 | 100/100 | 100/100 | 100/100 | 100/100 |
| | minutes | | | | |
| | 140° C., 20 | 100/100 | 100/100 | 100/100 | 100/100 |
| | minutes | | | | |
| | 160° C., 20 | 100/100 | 100/100 | 100/100 | 100/100 |
| | minutes | | | | |

TABLE 9

| | | First coat | | | |
|---|---|---|---|---|---|
| | | 100° C., | 120° C., | 140° C., | 160° C., |
| | | 20 | 20 | 20 | 20 |
| | | minutes | minutes | minutes | minutes |
| Second | 100° C., 20 | 100/100 | 100/100 | 100/100 | 95/100 |
| coat | minutes | | | | |
| | 120° C., 20 | 100/100 | 100/100 | 100/100 | 100/100 |
| | minutes | | | | |
| | 140° C., 20 | 100/100 | 100/100 | 100/100 | 100/100 |
| | minutes | | | | |
| | 160° C., 20 | 100/100 | 100/100 | 100/100 | 100/100 |
| | minutes | | | | |

As shown in Tables 5 to 9, results were obtained for Example 1 such that, since the acid number of the acrylic resin was 6.5 mg KOH/g, adhesion was extremely low regardless of the conditions for the second coat when the conditions for the first coat were 140° C. or 1600° C. In Example 19, since the acid number of the acrylic resin was 2.6 mg KOH/g, although adhesion was extremely low regardless of the conditions for the second coat when the conditions for the first coat were 1600° C., satisfactory adhesion was demonstrated when the conditions for the first coat were 140° C. and the conditions for the second coat were 1200° C. or higher. In contrast, in Examples 20 to 22, since the acid number of the acrylic resin was 0 mg KOH/g, adhesion was extremely satisfactory regardless of the conditions. In addition, adhesion was demonstrated to be adequately maintained even when an additive was added (Example 21) and when a foam breaker was added (Example 22).

Furthermore, the aforementioned embodiments can also be embodied by making the changes described below.

Compounds in which the average values of the number of caprolactone repetitive units mutually differ can also be used in combination for the caprolactone-modified hydroxyalkyl (meth)acrylate.

A long-chain alkyl may also be added to the coating composition. This improves the surface smoothness of the coated film, and as a result, improves scratch resistance while also being able to impart antistatic effects.

A silicone-based compound or fluorine-based compound may also be added to the coating composition. When this is done, the surface smoothness of the coated film improves, and as a result, scratch resistance is also improved.

Examples of means for coating a coating composition onto the surface of a coated material followed by drying and curing include active energy beams such as ultraviolet rays and electron beams.

Three or more coats of the coating composition can be repeatedly coated and cured on the surface of a coated material, and three or more layers of a coated film can be formed.

1. A coating composition comprising: a (meth)acrylic resin (A) having a hydroxyl group, which is obtained by copolymerizing a mixture having for its essential components a polycaprolactone-modified hydroxyalkyl (meth)acrylate and a different hydroxyl-group containing (meth)acrylate, and a polyisocyanate compound (B) having a plurality of isocyanate groups; wherein
the hydroxyl group of the hydroxyl group-containing (meth)acrylate is a primary hydroxyl group, and the hydroxyl number of the (meth)acrylic resin (A) is 125 to 145.

2. The coating composition according to claim 1, wherein the average value of the number of caprolactone repetitive units in the polycaprolactone-modified hydroxyalkyl (meth)acrylate is 1 to 3.

3. The coating composition according to claim 1, wherein the polycaprolactone-modified hydroxyalkyl (meth)acrylate is a polycaprolactone-modified hydroxyalkyl acrylate.

4. The coating composition according to claim 1, wherein a monomer having a cyclic backbone is contained in the monomer mixture, and the monomer having a cyclic backbone is contained at 10% by mass or less in the monomer mixture.

5. The coating composition according to claim 1, further comprising a lactone polyole (C) having three or more hydroxyl groups.

6. The coating composition according to claim 1, wherein the acid number of the (meth)acrylic resin (A) is 30 mg KOH/g or less.

7. A coated article comprising: material having a surface with a coating including a (meth)acrylic resin (A) having a hydroxyl group, which is obtained by copolymerizing a mixture having for its essential components a polycaprolactone-modified hydroxyalkyl (meth)acrylate and a different hydroxyl-group containing (meth)acrylate, and a polyisocyanate compound (B) having a plurality of isocyanate groups; wherein the hydroxyl group of the hydroxyl group-containing (meth)acrylate is a primary hydroxyl group, and the hydroxyl number of the (meth)acrylic resin (A) is 125 to 145 and curing to form a coated film on the surface of the coated material.
